(19) United States
(12) Patent Application Publication
(10) Pub. No.: US 2003/0146660 A1
(43) Pub. Date: Aug. 7, 2003

(54) Brake booster with seal joint

(76) Inventors: Gendrin Stephane, Bruz (FR); Jean Fourcade, Champs Sur Marne (FR); Fernando Sacristan, Bardelona (ES); Cyrill Divoux, Emerainville (FR)

Correspondence Address: Leo H McCormick Jr, 2112 Mishawaka Avenue, PO Box 4721, South Bend, IN, 46634-4721, US

(21) Appl. No.: 09/979,794

(22) PCT Filed: Sep. 3, 2001
(86) PCT No.: PCT/FR01/02733

(30) Foreign Application Priority Data
Sep. 7, 2000 (FR) 00/11498

(51) Int. Cl. B60T 8/44

(52) U.S. Cl. 303/118.1; 303/114.3

(57) ABSTRACT

In order to solve the problem of the passing of an elbow piece (15) with a right-angle bend (16) through an opening (21) in a seal (19), said seal (19) is provided with a deformable slot (20). The tightness of the system, consisting of the seal (19) and the elbow piece (15), results from the existence of fir-branch shaped protrusions (27) on the base (26) of the elbow piece (15).

This invention relates to a pneumatic servobrake and the object of the invention consists in simplifying the manufacture of such servobrakes for a better cost control and, in the first place, for a more reliable structure. More generally, the scope of the invention is that of seals, acting like an interfacial joint between two spaces. The object of this invention consists in letting variable-section pieces, such as an angularly-bent tube, pass through an opening, in which the seal is placed between two chambers of a servobrake.

Fundamentally, a pneumatic servobrake comprises a variable-volume front chamber, separated from a variable-volume rear chamber by a partition wall, consisting of a tight flexible diaphragm and a rigid skirt-forming plate. The rigid skirt drives a pneumatic piston which bears, through a push rod, on the primary piston of a master cylinder of a hydraulic braking system, typically a tandem master cylinder. The front chamber, directed towards the master cylinder, is pneumatically connected to a vacuum source whereas the rear chamber, in the opposite direction to the front chamber and on the side of a brake pedal, is pneumatically connected, under a valve control, to a propellant fluid source, typically atmospheric-pressure air. At rest, that is when the driver does not depress the brake pedal, the front and rear chambers are interconnected, while the rear chamber is isolated from the atmospheric pressure. On braking, first the front chamber is isolated from the rear chamber and then air is admitted into the rear chamber. Such air entrance imparts a propulsive motion to the partition wall, thus actuating the pneumatic braking assistance.

Besides, hydraulic brake assisting systems are known, in which an electric motor is conventionally connected to a hydraulic pump, injecting a pressure fluid into the brake circuit when it is actuated. The electric motor is controlled on the basis of the measurement of the pressures within the front and rear chambers of the pneumatic servobrake. Therefore, two pressure sensors are pneumatically connected to each chamber, so as to measure the fluid pressure in it. These sensors output electrical signals, indicative of the pressures. For convenience sake, the pressure sensors are installed on an outer wall of the front chamber, close to the master cylinder. As regards the measurement of the pressure in the front chamber, one only has to make a hole in the front chamber and place a pressure sensor opposite such hole.

As for the measurement of the pressure in the rear chamber, the choice taken consists in drilling the partition wall between the chambers and in installing, in the opening thus made, a tight tube, extending within the front chamber and opening into a second hole, made in the latter. A second pressure sensor is set opposite this second hole. The tube is a flexible one and, furthermore, it enables the partition wall to move inside both chambers. Owing to the fact that the partition wall can take forward and backward positions, with a great range in the first chamber, the tube is manufactured in the shape of an unfolding spiral. The spiral pitch can be reduced or widened, depending on whether the partition wall is in a forward or a backward position in the chambers. The seal according to this invention is, more particularly, one which enables the flexible hose to sample the pressure in the rear chamber, without giving rise to a loss of tightness between the chambers.

Such a seal, which is embedded in the partition wall, defines a through-opening for the passage of a piece. The passing of a uniform piece through such an opening is well known, and its placement is easy as far as a rubber seal, with a conventional hardness, is concerned. In actual fact, the hardness of rubber is in the order of 50 Shore A (in which A means the ambiant temperature). On account of the helical path of the hose, at the partition wall, the sampling is carried out by means of an elbow pipe which therefore, must pass through the seal. As a matter of fact, its is quite possible to let an non-uniform piece, and especially an angularly bent one, through such seals. In this case however, the passage of the bend means that the rubber must be soft but then the tightness is poor. For all that, it is also possible to use a soft rubber while providing a satisfactory tightness, which implies the use of reinforcing inserts in the soft rubber joints, for the achievement of such tightness.

In order to solve this problem, resulting from the fact that the required hardness of rubber, associated with tightness, is incompatible with the softness that a rubber seal must exhibit to allow the insertion of a bent piece, the present invention suggests that a slot should be made in the seal. In such a way, the slot gets out of shape on the passage of a bent piece. Such slot leads to a local decrease in the macroscopic hardness and thus the opening is distorted in such a manner that a variable-section bent piece can pass through it. As for the tightness, it retained thanks to the hardness of the selected rubber, at the spot between the seal and the inserted piece. Preferably, the tightness will be even improved, in that fir-branch shaped protrusions are provided on the bent piece, where the latter is in contact with the seal. The invention will also show how, thanks to a suction phenomenon, the tightness is still improved, if the truncated-cone tops, formed by these protrusions, are directed towards a lower-pressure chamber.

Therefore, the present invention deals with a pneumatic servobrake, comprising a front chamber, capable of being connected to a vacuum source, a rear chamber, which can be connected to a high-pressure supply inlet, a moving tight partition wall between said chambers, a moving set carried along by the partition wall and connected to a hydraulic braking circuit, a device provided for the supply of the rear chamber with a high-pressure fluid at the time of a braking operation, a seal for a passage through the tight partition wall, and a hollow bent tube passing through the seal, characterised in that the seal comprises a slot, which can be distorted to some extent for the passage of a bend of the hollow bent tube.

Other features and advantages of the present invention will be apparent from the following detailed description, by way of example and by no means as a limitation, when taken in conjunction with the accompanying drawings, in which:

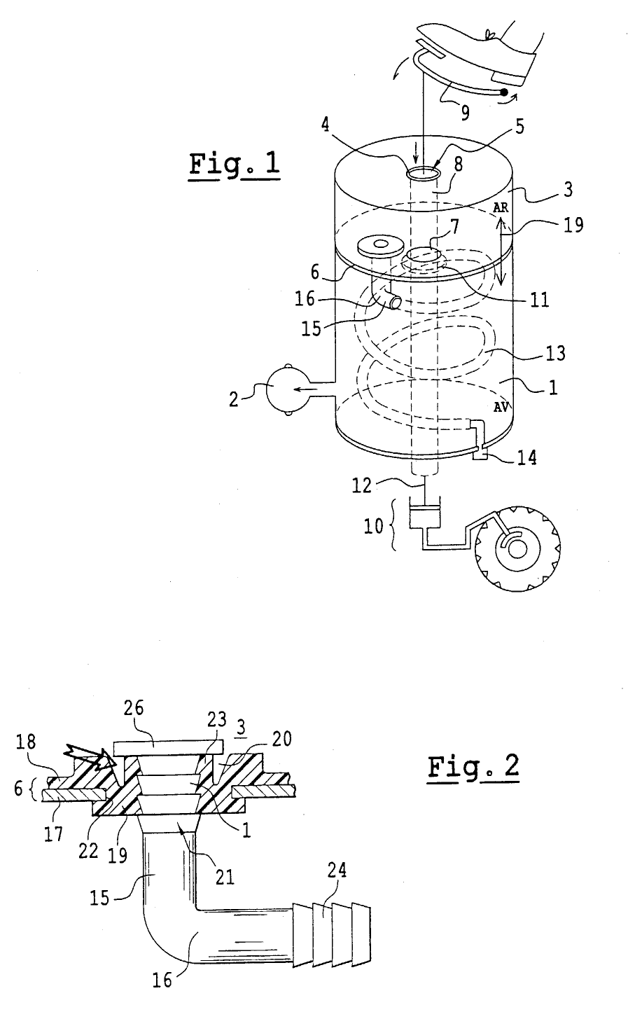

FIG. 1 is an illustration of a pneumatic servobrake according to the-present invention;

FIG. 2 shows some details of a seal comprising a slot;

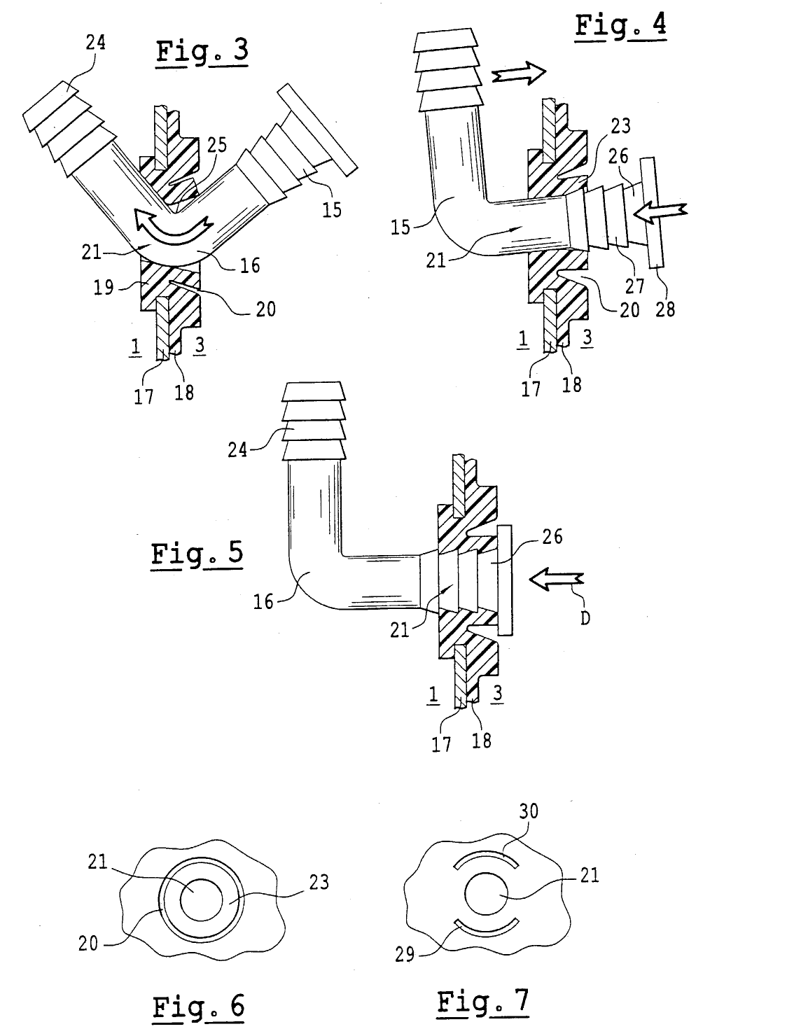

FIGS. 3 to 5 show steps of the installation process of a bent piece into the seal; and

FIGS. 6 and 7 are schematic illustrations of a diaphragm of a servobrake, with two types of slots.

FIG. 1 shows a pneumatic servobrake according to this invention, which comprises a front chamber 1, connectable to a vacuum pump 2. In a typical manner, the pump 2 may consist of an offtake of the intake gas in a gasoline engine of a vehicle. In the case of a Diesel engine, an outer vacuum pump would be used. The servobrake also comprises a rear chamber 3, which can be connected, e.g. through a valve 4, schematically represented here, to a high-pressure supply inlet 5, conventionally ambiant air. Besides the servobrake comprises a moving partition wall 6, usually fitted with a rigid skirt and a tight diaphragm. This diaphragm prevents a pneumatic communication between the chambers. A fluidproof opening 7 is pierced through the partition wall 6 so as to let a moving set 8 through. The set 8 is mechanically connected, on the one hand, to a brake pedal 9 and, on the other hand, to a hydraulic braking circuit 10. The assistance principle of such a servobrake is as follows. When the brake pedal 9 is depressed, the moving set 8 plunges into the rear chamber, thus exposing the valve 4, through which ambiant air flows into the rear chamber 3. At this time, the ambiant air presses on the partition wall 6 which drives, through a support 11 integral with the moving set 8, the moving set 8 in such a way that an end 12 of the latter actuates the hydraulic braking circuit 10.

The servobrake also comprises a helical flexible hose 13. In a preferred embodiment, the helical flexible hose 13 permits a leakproof connection of the rear chamber 3 with a pressure sensor 14, mounted at the front part of the front chamber. The helical flexible hose 13 opens into the rear chamber 3, through an elbow pipe 15, traversing the partition wall 6. The elbow pipe 15 is a variable-section piece, more especially at a bend 16. Therefore, the elbow pipe forms a hollow bent tube and the seal according to this invention is intended for the leakproof fastening of this elbow pipe 15 to the partition wall 6.

FIG. 2 shows, in a sectional view, that, in a preferred embodiment, the partition wall 6 consists of two parts, namely a skirt 17 and a diaphragm 18. The skirt 17 is used as a force-transmitting element for the moving fit 8, when resting on the support 11. The diaphragm 18 tightly separates the chambers 1 and 3 and, by its extended surface under an overpressure, it pushes the skirt 17. As a matter or fact, on braking, the front chamber 1 and the rear chamber 3 are not subjected to the same pressure. Thus, the front chamber 1 is subjected to a low pressure, set by the vacuum pump and the rear chamber 3 is under a higher pressure, more particularly the atmospheric pressure.

A seal 19 according to this invention makes it possible to connect, in a leakproof manner, the outer surface of the elbow pipe 15 to the diaphragm 18. The seal 19 is preferably incorporated in the diaphragm 18, in which case the seal is integral with the latter. The diaphragm 18 and the seal 19 are made of rubber, more particularly a hard rubber having a Shore hardness in the order of 50 Shore A. According to the invention, the seal 19 comprises a slot 20, here with a triangular profile and it extends, by revolution, all the way about an opening 21, through which the elbow pipe 15 passes. The slot shape could also be rectangular or even rounded. Even if the seal 19 is not integral with the diaphragm 18, it is, in any case, connected to the latter in a leakproof manner. The seal 19 rests on the edges of an opening 22, made in the skirt 17, and the opening 21 is situated within the opening 22. The seal 19 reappears on the other side of the partition wall 6 and it covers the edges of the opening 22. The object of the slot 20 is to allow a distortion of the seal 19 for an easier insertion of the bend 16 of the elbow pipe 15, even though the seal 19 is made of a hard rubber.

The slot 20 defines a lip 23 and, when the slot 20 is a circular peripheral one, the lip is circular peripheral too. The slot 20 and the lip 23 are located on the side of the seal, which is subjected to the higher pressure. Thus in the embodiment presently described, the slot 20 is directed towards the rear chamber 3. The grounds of such a solution will be more fully explained farther on. Yet the slot and the lip could also be located in the seal 19, in the direction of the front chamber 1, or slots might also be cut on each side of the partition wall 6. The slot can be wider or narrower. If it is very wide, the height of the seal results, in actual fact, from the existence of the lip. In this case however, the tightness is less satisfactory because the massive nature of the seal, the solid (or almost solid) body of which ensures the resting of the inner surface of the lip on the outer surface of the elbow pipe, is less marked. Preferably, the space defined by the slot is slightly smaller that the volume increase caused by the passage of the bend through the seal.

FIGS. 3 through 5 show the various steps concerning the installation of the elbow pipe 15. FIG. 3 show a first installation step. In the first place, an adapter 24 of the elbow pipe 15 is inserted in the opening 21, along a straight line, till the bend 16 touches the seal 19. The reason for the larger cross-section area of the elbow pipe 15, at the bend 16, is that the elbow pipe 15 is made by plain moulding. Since the pipe is hollow, two rods (straight ones) are disposed in the mould so as to provide for the inner space of the tube 15, and they are easily removed, in a linear movement, during the unmoulding operation. This procedure is quite suitable for a quantity production at a low cost, but it results in the occurrence of the angular bend 16. On the one hand, a rounded bend would not lead to a change in the cross-section area for the passage through the seal 19 but, on the other hand, it would mean a higher cost of the elbow pipe 15. Besides, such an elbow pipe, with a rounded bend, would be less easily handled during the mounting operation.

FIG. 3 also shows a second step of the mounting process for the elbow pipe 15. When the bend 16 is in contact with the seal 19, the elbow pipe 15 is rotated. The rotation center is a contact point 25 between the reentrant angle of the bend 16 and the seal 19. The elbow pipe 15 is driven in, while being rotated in the opening 21, such rotation being possible because there is a slot 20. As a matter of fact, a slot 20 enables the lip 23 to get out of shape. Under those circumstances, the deformation changes the shape of the opening 21 for the passage of the elbow pipe. Here, the elastic deformation looks somewhat like an ellipse. The major axis of the ellipse is the intersection of the diaphragm plane with that of the elbow pipe. Therefore, the deformation of the through-opening 21 enables the elbow pipe 15 to be driven in. The result of the existence of the slot 20, or the slots on both sides of the partition wall 6, is a limitation of the rotational tilting plane of the elbow pipe 15 to a small height in the seal 19. Such a small height is the seat of a strong compression of the material, constituting the seal 19, so as to let the bend 16 through, but this strong compression is limited in height and therefore the bend can be run through, with no risk of disruption of the elbow pipe 15 and/or the seal 19.

FIG. 4 shows the third mounting step. Once the bend 16 of the elbow pipe 15 has passed, then the elbow pipe must be permanently installed. To this end, it comprises, close to a base 26, on the one hand, fir-branch shaped protrusions 27 (the so-called “firs” in common language) and, on the other hand, a collar 28, which crowns the elbow pipe 15, while projecting from it. The object of the third step consists in letting the fir-branch shaped protrusions 27 of the base 26 go deep into the opening 21, in a translatory motion. At such point as well, the deformation of the slot 20 makes the driving of the elbow pipe 15 much easier.

FIG. 5 shows the last step of the driving of the elbow pipe 15 through the opening 21. The driving operation, which is a translatory motion along the axis of revolution of the opening 21, goes on so long as the collar 28 of the base 26 is not in contact with the seal 19. When this occurs, then the fir-branch shaped protrusions 27 at the base 26 ensure the tightness of the system, consisting of the seal 19 and the elbow pipe 15. In the present example, the fir-branch shaped protrusions form truncated cones, the tops of which are directed towards the front chamber 1. Such arrangement results in two simultaneous effects. In the first place, the sharp edges of the fir-branch shaped protrusions do not interfere with the driving in of the elbow pipe 15 (on the contrary, they slide in the required direction) and, in the second place, such a design of the fir-branch shaped protrusions contributes to the preservation of the tightness, owing to the fact that the pressure within the chamber 3 is higher than in the chamber 1. As regards the latter point, if the fir-branch shaped protrusions had been situated in the other direction, the tightness would have been less satisfactory, maybe inadequate. It should be noted that the question of the orientation of the fir-branch shaped protrusions is of importance, since it gave rise to the problem which the present invention had to solve. Otherwise, a plain scheme would have consisted in slipping the base of the elbow pipe 15 (without the collar 28) into the seal 19. In the preferred embodiment, the adapter 24 comprises four fir-branch shaped protrusions and the base 26, three of them.

FIG. 5 shows how the fir-branch shaped protrusions are embedded in the seal 19. The fir-branch shaped protrusions are closely pushed and fitted into the seal 19 with a squeezing force P resulting in a suction phenomenon. The top of the fir-branch shaped protrusions is on the side of low pressures. Had the fir-branch shaped protrusions been designed in the other direction, such close fitting would have been possible, but the squeezing force would have tended to drive out the elbow pipe.

The elbow pipe 15 is inserted into the opening 21 from the chamber subjected to the higher pressure towards the chamber with a lower pressure. Pressure is just as important as the hardness of the material of the seal 19 itself, since there is a close connection between the tightness and the rubber hardness. If the rubber is not hard enough, the elbow pipe 15 can be let through more easily but the assembly does not exhibit a satisfactory tightness. Once the collar 28 is in contact with the seal 19, it might be possible to fill the slot 20, e.g. with a rubber washer.

FIG. 6 is a top view, showing a first embodiment of the slot 20. Thus the slot 20 may be located peripherally in relation to the opening 21, more particularly it can be a circular one. FIG. 7 shows another possible design for the slot 20, which may consist of two separate cavities 29 and 30, with an elongate shape. One of the cavities, or both cavities, may be in the shape of an arc of a circle, but each of them could also look like a linear segment. Generally, if such a solution is chosen, the cavities 29 and 30 will be perpendicular to the major axis of the ellipse, to be formed in the seal 19 when the bend 16 is run through it. In this variant, the lip 23 is not a peripheral one, but instead limited by the ends of the cavities.

1. Pneumatic servobrake, comprising a front chamber (1), capable of being connected to a vacuum source (2), a rear chamber (3), which can be connected to a high-pressure supply inlet, a moving tight partition wall (6) between said chambers, a moving set (8) carried along by the partition wall and connected to a hydraulic braking circuit (10), a device (4) provided for the supply of the rear chamber with a high-pressure fluid at the time of a braking operation, a seal (19) for a passage through the tight partition wall, and a hollow bent tube (13) passing through the seal, characterised in that the seal comprises a slot (20), which can be distorted to some extent for the passage of a bend of the hollow bent tube.

2. Servobrake according to claim 1, characterised in that the partition wall comprises a skirt (17) and a diaphragm (18), said seal being integral with the diaphragm.

3. Servobrake according to claim 1 or 2, characterised in that the slot forms a lip (23), more particularly a circular peripheral one.

4. Servobrake according to any one of claims 1 to 3, characterised in that the slot is situated on the side of the rear chamber.

5. Servobrake according to any one of claims 1 to 4, characterised in that said bent tube has an angular bend.

6. Servobrake according to any one of claims 1 to 5, characterised in that the bent tube comprises protrusions (27), at the spot where it is retained within the seal.

7. Servobrake according to claim 6, characterised in that the protrusions are in the shape of fir branches.

8. Servobrake according to claim 7, characterised in that the fir-branch shaped protrusions form truncated cones, the tops of which are directed towards the front chamber.

9. Servobrake according to any one of claims 1 to 8, characterised in that a distortion of the through-opening is an ellipse, the major axis of which is the greatest length defined by a cross section of the bend of the bent tube.

10. Servobrake according to any one of claims 1 to 9, characterised in that the seal comprises two separate slots (29, 30), preferably in the shape of an arc of a circle.
